(19) United States
(12) Patent Application Publication
(10) Pub. No.: US 2024/0146672 A1
(43) Pub. Date: May 2, 2024

(54) SYSTEM AND METHOD FOR DYNAMIC SIGNALING OF ONLINE USER ACTIVITY

(71) Applicant: Pushnami LLC, Austin, TX (US)

(72) Inventors: Emerson Smith, Austin, TX (US); Mitchell Taylor, Austin, TX (US)

(21) Appl. No.: 18/478,367

(22) Filed: Sep. 29, 2023

Related U.S. Application Data
(60) Provisional application No. 63/413,125, filed on Oct. 4, 2022.

(51) Int. Cl. H04L 51/043; H04L 51/02

(52) U.S. Cl. CPC H04L 51/043; H04L 51/02

(57) ABSTRACT

Systems and methods for dynamic online signaling are disclosed. Embodiments of these systems and methods may determine when a user is online or when a user is otherwise performing certain activities and dynamically signal an interested entity based on the user's activity.

### RELATED APPLICATIONS

This application claims the benefit of priority under 35 U.S.C. § 119 to U.S. Provisional Application No. 63/413,125, entitled “SYSTEM AND METHOD FOR DYNAMIC SIGNALING OF ONLINE USER ACTIVITY,” filed Oct. 4, 2022, which is hereby fully incorporated by reference herein for all purposes.

### TECHNICAL FIELD

This disclosure relates generally to the determination of real time information from users of websites or applications and providing indications or reporting data related to such information. More particularly, embodiments of this disclosure relate to the identification of user online behavior and providing signals related to such behavior to online entities.

### BACKGROUND

In the current online environment it is desirable to contact users at various points during the online activity. Entities that contact these users, however, may have little information on when such users should be contacted. For example, currently, call centers and web notification software or other online entities do not have visibility into what a user is doing online (or if the user is online at all) at the time they are being contacted by these entities (either by phone, email, push notification, pop ups such as chatbots, etc.). In particular, entities that advertise or sell to consumers via any direct method, such as push notifications, email, SMS or phone calls are not aware of what the user is doing at the time they make contact. Currently, entities contact users randomly (or at set certain times/days, etc.) at various times throughout the day in hopes that the user would want to, or be willing to, engage with them at that time. Accordingly, the user may not be in a desirable state for such contact. For example, a user may, or may not be ready to enter a purchasing channel for a specific good or service being advertised and, as such, that user touch-point is wasted. Therefore, a lot of time and resources may be uselessly spent on contacting users at inopportune times (e.g., because they are not prepared to interact or otherwise be responsive at that point in time). Moreover, too many of these contacts at the wrong time could serve to alienate a user.

What is desired, therefore, is to determine opportune times to contact a user based on users' online activities. Specifically, what is desired is to determine when a user is online or when a user is otherwise performing certain activities and dynamically signal an interested entity based on the user's activity.

### SUMMARY

As discussed, it is desirable to contact users at various points during the online activity. In particular, it may be desired to determine opportune times to contact a user based on a user's online activities. Accordingly, embodiments of systems and methods to determine when a user is online or when a user is otherwise performing certain activities and dynamically signal an interested entity of the user's activity are disclosed. In particular embodiments, such systems and methods may be adapted to determine when a user is online, and by collecting, ingesting or analyzing online events performed by that user, electronically interpret and determine objectives, goals or other interests for that users' activities while they are performing those activities. Embodiments may then use these determinations regarding users' activities to electronically notify (signal) appropriate online entities regarding the user and associated interest of the users or other data regarding the user or the user's online activities. For example, embodiments may automatically send data regarding the user or the events related to the user (e.g., including the user's interest) to a signal delivery channel for the one or more interested entities that desire to receive such signals.

In one embodiment, a signaling system may store a policy comprising a targeting rule and a signal delivery rule specifying a signal delivery channel and signal data. The signaling system can receive an event based on a user interaction with content at a user device of the user, where the content was provided from a content provider. The event may, for example, be sent from an agent on the user device. This can be associated with the policy based on an evaluation of the event and the targeting rule of the policy and a signal generated based on the association of the event with the policy. The signal may include the signal data specified in the signal delivery rule, such as an identifier for the policy and an identifier for the user. The generated signal can be sent to a signal recipient using the signal delivery channel specified in the signal delivery rule. The content provider and the signal recipient may be the same, or different, entities. Thus, a signal may be sent in real-time to a signal recipient (e.g., as the user is interacting with the content such as accessing or otherwise taking actions with respect to the content).

In some embodiments, generating the signal and sending the generated signal comprise sending a signal delivery instruction to the user device (e.g., an agent on the user device) where the signal delivery instruction is adapted to cause the signal to be generated at the user device and sent from the user device (e.g., the agent on the user device) to the signal recipient using the signal delivery channel. The signal data of the signal may thus include data stored at the user device.

Embodiments as disclosed may thus have a number of advantages. By sending such a signal to a signal recipient one event (or set of events) associated with a user may trigger a signal to one or more associated signal recipients in a dynamic manner as that user is online or at the time a user is expressing a particular interest or taking another online activity. Moreover, in certain embodiments that signal may be sent from the very user device which generated the event that resulted in such a signal being sent, allowing proprietary or other data stored on the user device to be sent in the signal. Additionally, such a signal may be sent from that user device to a signal recipient that is not associated with the content being viewed or interacted with at the device by the user that triggered that event, and where the signal recipient may be different than the content provider that provided such content.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIGS. 1A and 1B are diagrammatic representations of network architectures including embodiments of a signaling system.

FIGS. 2A-1, 2A-2, 2B-1 and 2B-2 are diagrammatic representations of a network architecture including embodiments of a signaling system.

FIG. 3 is a flow diagram for one embodiment of a method for sending a signal.

FIG. 4 is a concept map of one embodiment of a signal policy.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Before discussing embodiments in more detail a brief description of the context in which embodiments can be utilized may be helpful. In the current online environment it is desirable to contact users at various points during the online activity. Entities that contact these users, however, may have little information on when such users should be contacted. For example, currently, call centers and web notification software or other online entities do not have visibility into what a user is doing online (or if the user is online at all) at the time they are being contacted by these companies (either by phone, email, push notification, etc.). In particular, entities that advertise or sell to consumers via any direct method, such as push notifications, email, SMS or phone calls are not aware of what the consumer is doing at the time they make contact. Currently, entities contact users randomly (or at set certain times/days, etc.) at various times throughout the day in hopes that the consumer would want to, or be willing to, engage with them at that time. Accordingly, the user may not be in a desirable state for such contact. For example, a user may, or may not be ready to enter a purchasing channel for a specific good or service being advertised and that user touch-point is wasted. Therefore, a lot of time and resources are wasted on contacting users at inopportune times (e.g., because they are not prepared to purchase or otherwise be responsive at that point in time). Moreover, too many of these contacts at the wrong time could serve to alienate the consumer.

What is desired, therefore, is to determine opportune times to contact a user based on users' online activities. Specifically, what is desired is to determine when a user is online or when a user is otherwise performing certain activities (e.g., associated with a particular interest) and dynamically (e.g., substantially in real time or semi-real time) signal an interested entity of the user's activity (e.g., presence online, interests or other data related to user events).

Accordingly, embodiments of systems and methods to determine an opportune time to contact a user have been developed. In particular embodiments, such systems and methods may be adapted to determine when a user is online, and by collecting, ingesting or analyzing online events performed by that user, these systems and methods may electronically interpret and determine objectives, goals or other interests for that users' activities while they are performing those activities. Embodiments may then use these determinations regarding users' activities to electronically notify (signal) appropriate online entities regarding the user and associated interest of the users. For example, embodiments may automatically send data regarding the user or the events related to the user (e.g., including the user's interest, content the user is viewing, or other user data, etc.) to a signal delivery channel (e.g., REST interface, API, etc.) for one or more interested entities.

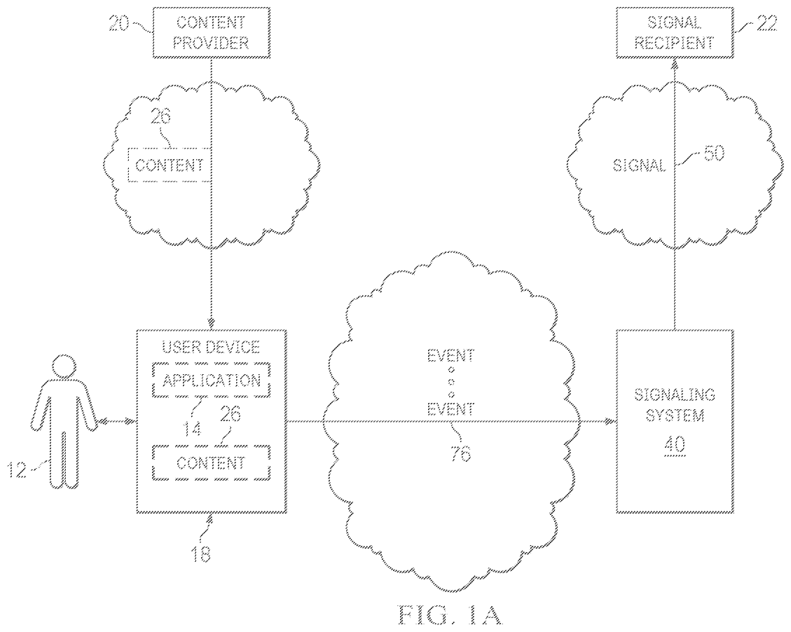

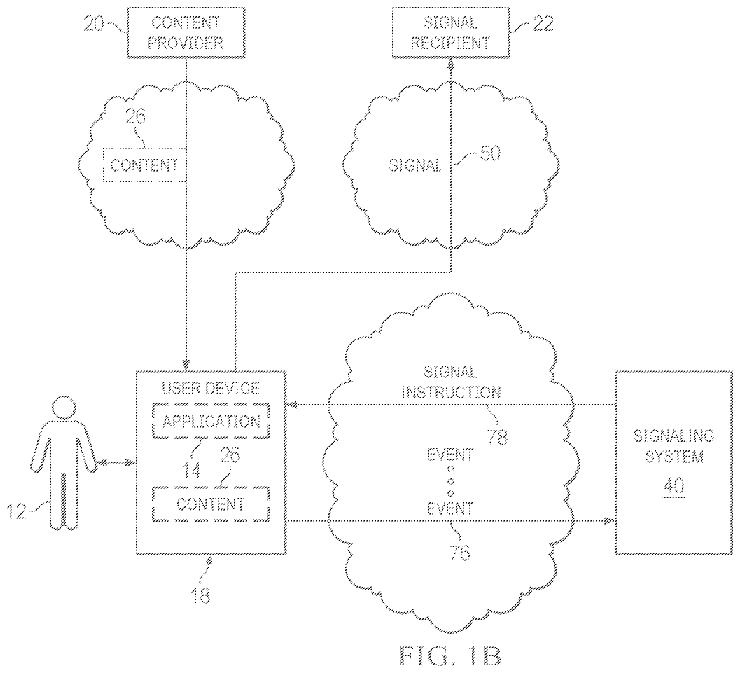

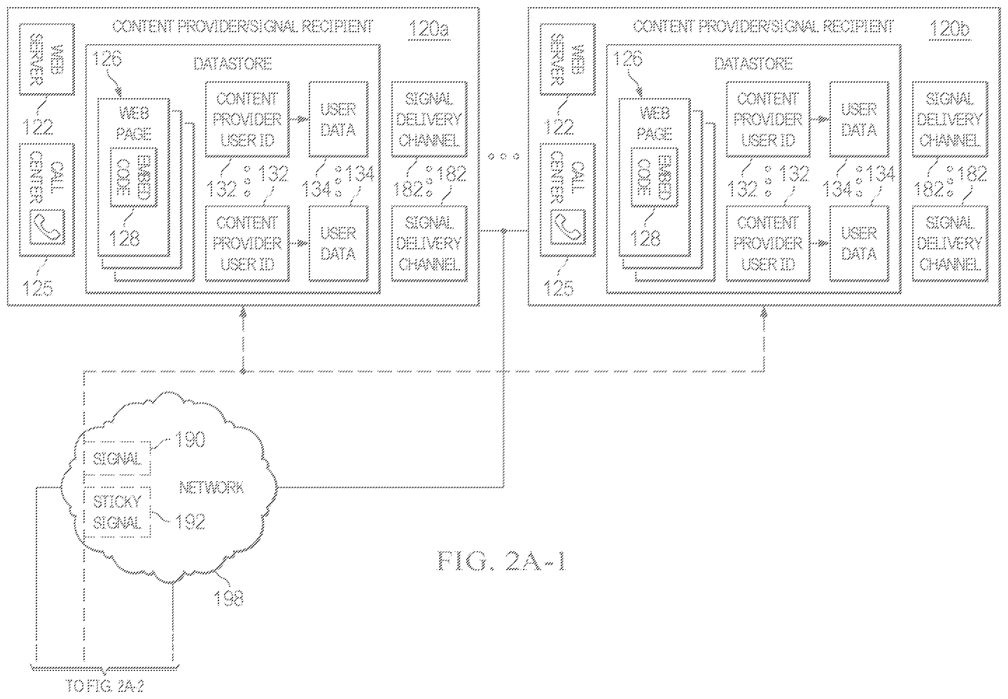

Looking at FIGS. 1A and 1B, then, diagrams of architectures of distributed network computer systems for dynamic signaling including embodiments of signaling systems are disclosed. Referring first to FIG. 1A, a network environment may include content provider 20, signaling system 40 and user device 18 coupled to one another over one or more networks such as the Internet, a wide area network (WAN), a local area network (LAN), an intranet, an internet, a wired network, a wireless network (including a cellular network), or some combination thereof.

Content provider 20 may be any for-profit or non-profit organization or entity (used herein interchangeably) that, as part of its operations, conducts online activity. Accordingly, content provider 20 may provide content (e.g., almost any electronic information, including a web page, portion of a web page, advertisement, audio or video content, code, etc.) to a user 12 at user device 18. Additionally, or alternatively, content provider 20 may provide content 26 through an application 14 (e.g., an “app”) that is executed or installed on a user device 18, or may provide the application 14 itself.

Signal recipient 22 may desire to have signals 50 provided to them based on users' online activities. Specifically, signal recipient 22 may desire to have signals provided to them when users are online (e.g., are receptive to content), when they access particular content (e.g., associated with various interests), or when (or after) they take particular activity online. For example, signal recipient 22 may desire to have signal 50 provided to them based on users' online activities, even when those online activities occur with respect to web sites (e.g., domains) or communication channels that are not affiliated with that signal recipient 22 (e.g., when such online activities occur in association with a web pages or content that are not provided by, or may otherwise be unaffiliated with, signal recipient 22, etc.).

In one embodiment, therefore, signal recipient 22 can define one or more rules associated with signals 50 to be provided to signal recipient. These rules may be defined by interactions with signaling system 40 (e.g., through an interface offered by signaling system 40 or to an administrator or operator of signaling system 40) such that the rules may be accessed by signaling system 40 (e.g., a definition of the rules can be stored in a storage location associated with signaling system 40). These rules may include rules defining desired user characteristics (e.g., age, interests or “verticals”, level of activity, etc.), rules regarding restriction, timing or delivery that define where, when, or how signal 50 should be sent, rules defining data to be provided in signal 50, or other types of rules.

Signaling system 40 may thus provide signals 50 to signal recipient 22 in accordance with such rules based on users' online activities, where such signals 50 may be sent substantially in real-time as user 12 is accessing or interacting with content 26 or subsequently to such interactions. In particular, as user 12 at user device 18 requests, or interacts with, content 26, events 76 may be sent from user device 18 to signaling system 40. These events 76 may include data on user 12, data on content 26, data on interactions between user 12 and content 26 or other types of user online activity data.

Signaling system 40 can receive these events 76 and associate these events 76 with user 12 interacting with content 26 at user device 18 or the rules for signaling as defined by signal recipient 22. Signaling system 40 can analyze these events 76 according to the rules defined by signal recipient 22 (or administrator or other user associated therewith) and determine signal 50 is to be sent to signal recipient 22 if one or more events 76 or sets of events 76 meets these rules (e.g., the characteristics or interests of user 12 meet conditions specified in rules defined by signaling recipient, or events 76 indicate an action specified in a rule, etc.). Signal 50 associated with user 12 may then be sent from signaling system 40 to signal recipient 22. Signal 50 may include any data specified in rules defined by signal recipient 22 such as data regarding user 12 including, for example, user identifying information (e.g., a user identifier such as email, assigned unique identifier, etc. that may be hashed (MD5)), data regarding content 26, data regarding events 76, or other data associated with user 12 or the user's online activity. Additionally, signal 50 may be sent or otherwise provided to signaling recipient 22 according to the mechanism (e.g., interface, destination, location, etc.) specified in the rules defined by signal recipient 22.

For a variety of reasons it may be undesirable to send a signal to a signal recipient from the signaling system. It may instead be desired to send the signal from the user device itself. In the main, the desire to send signals from the user device stems from the ability to include data that is only available on user device when sending signals from the user device, or because it may be objectionable or otherwise undesirable to send such data from the user device to the signaling system (e.g., in an event) for provisioning in a signal. For example, in some instances, content is provided from a content provider that is distinct from a signal recipient. While a user's interaction with such content may result in the generation of events that result in the sending of a signal to the signal recipient, there may be data on the user's device associated with the signal recipient that the signal recipient wishes to be provided in the signal to be sent to that signal recipient. (e.g., cookie or other data previously placed on the user's device by an application or web page associated with the signal recipient, a user identifier specific to the signal recipient). Accordingly, in certain embodiments, when a signaling system determines a signal is to be sent to a signal recipient, the signaling system may send a signaling instruction to the user device that causes the signal to be sent from the user device to the signaling recipient.

FIG. 1B depicts a network environment that includes an embodiment of just such a signaling system adapted to cause a signal to be sent from user device 18. In particular, as discussed above, signaling system 40 can receive events 76 from the user device and associate these events 76 with user 12 interacting with content 26 at user device 18 or signaling rules provided by signal recipient 22. Signaling system 40 can analyze these events 76 according to the rules defined by signal recipient 22 and determine that signal 50 is to be sent to signal recipient 22.

In this embodiment, signaling system 40 may send signaling instruction 78 to user device 18. This signaling instruction 78 may include, for example, an instruction to code on the user device 18 to send signal 50, data to be sent in signal 50, data to be obtained from user device 18 and include in signal 50, a mechanism (e.g., interface, destination, location, etc.) for providing signal 50 (e.g., as specified by signal recipient 22), or other signaling data. For example, the signaling instruction 78 may include a Universal Resource Locator (URL) or other location which may be accessed by code on the user device 18 to load code (e.g., a script available at the URL, a pixel associated with code that may be inserted into the DOM of a browser at the user device 18, etc.). The code loaded (or otherwise accessed or instructed) on the user device 18 may then generate signal 50 and send the signal 50. Thus, in response to receiving signaling instruction 78, signal 50 may be generated at user device 18 and sent from user device 18 to signal recipient 22 where signal 50 includes any data specified in rules defined by signal recipient 22 and is sent or otherwise provided to signaling recipient 50 according to the mechanism specified by signal recipient 22.

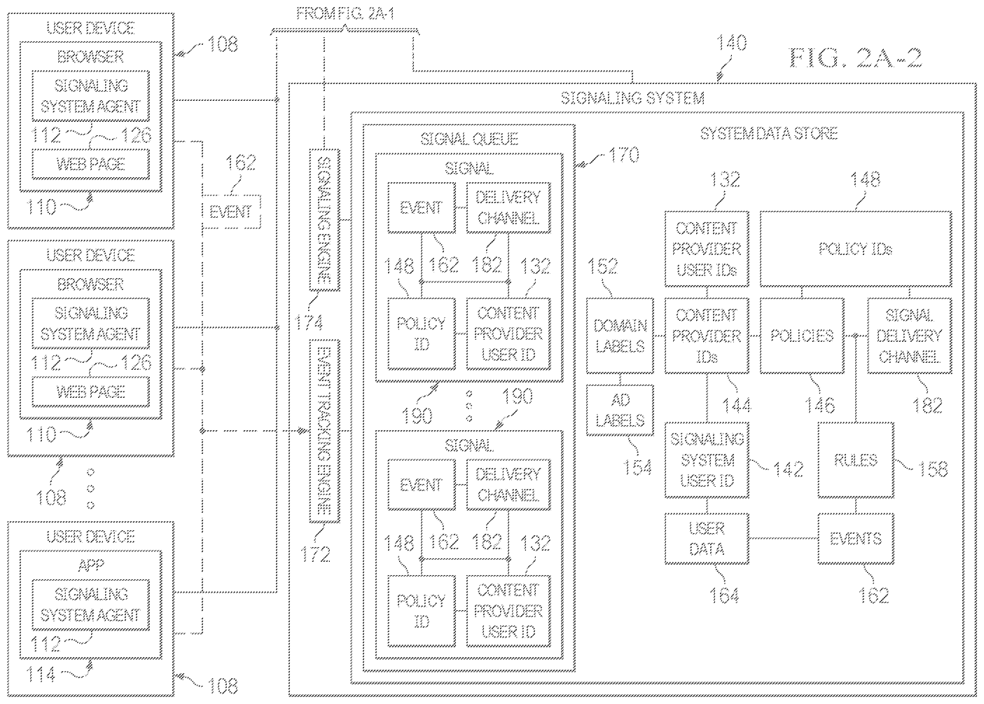

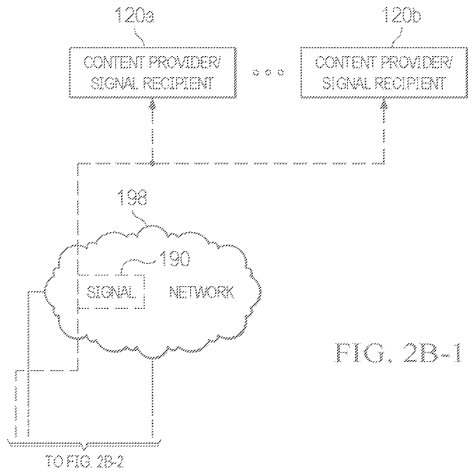

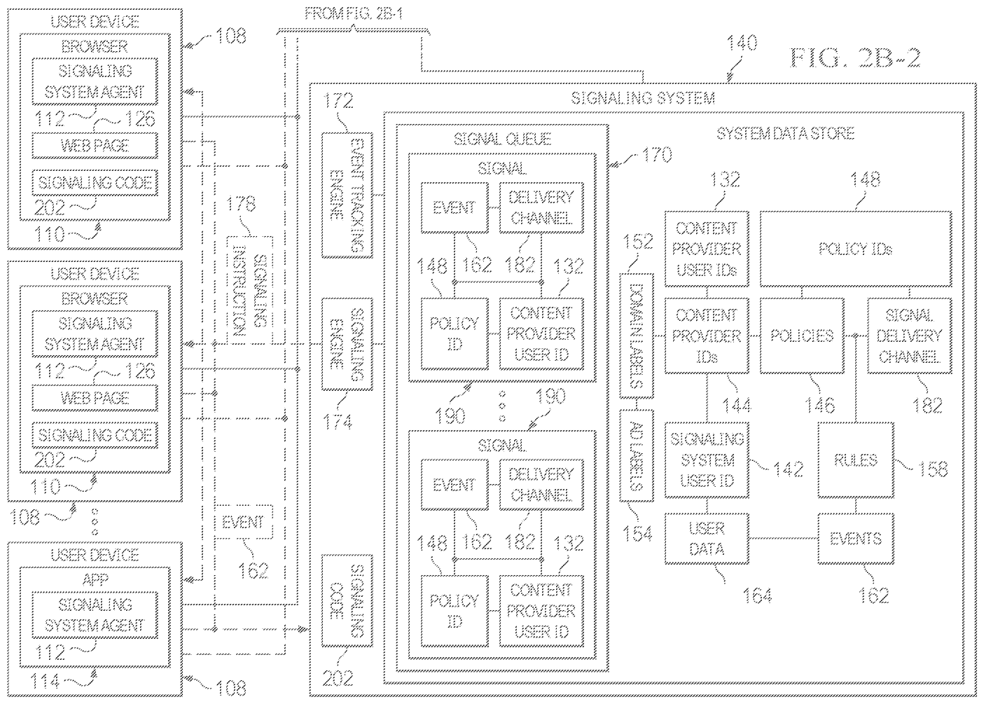

Moving now to FIGS. 2A-1 and 2A-2 (referred to collectively as FIG. 2A), a block diagram of a more detailed architecture of one embodiment of a distributed network computer system for dynamic signaling including an embodiment of a signaling system is disclosed. Signaling system 140 is coupled to user devices 108 and content providers/signal recipients 120 over network 198. Network 198 may be the Internet, a wide area network (WAN), a local area network (LAN), an intranet, an internet, a wired network, a wireless network (including a cellular network), or some combination thereof.

Content provider 120 may be an entity that conducts online activity. To facilitate interaction with users and conducting online activity with these users, the content providers 120 may include a web server 122 and one or more web pages 126 in an associated data store. These web pages 126 may, for example, be associated with one or more domains associated with the content provider 120. Users may access these web pages 126 through a browser 110 on user devices 108. These user devices 108 may be, for example, personal computers, laptop computers, mobile phones, watches or other wearable, or other data processing devices and may include a processor, a display (virtual or physical) and a user interface. Content providers 120 may also include other means of contacting users such as through call centers 125 or other user touch points which may be online or offline.

Accordingly, content providers 120 (e.g., 120a and 120b) may include user identifiers 132 (content provider user ids) associated with users who access their web sites or domains through web pages 126. Such a content provider user id 132 may be a unique value associated with the user such as an email or the like. For example, the content provider user id 132 may be a hash of a user's email (e.g., for security purposes) or other substantially unique identifier for a user. Such a content provider user id 132 may be an identifier of the user that may be common or utilized across multiple content providers 120 (e.g., again an email, telephone number or combination of identifiers, or hash of an identifier or combination of identifiers). Moreover, a content provider 120 may have user data 134 associated with such a content provider user id 132. This data may be data collected on, or provided by, a user accessing web pages 126 of the content provider 120.

For example, a user may subscribe to notifications from a content provider 120. Such users may have opted into, or otherwise provided permission, to “subscribe” to receive notifications or other data from a content provider 120 (e.g., through the content provider 120, web page 126 that they are accessing, or through another channel such as SMS, email, push notifications for an app, etc.). For example, a subscription can include a single messaging subscription which is generated when a user enables or allows notification permissions on a website. Content provider user ids 132 may be identifiers of users who have subscribed to receive notifications from the content provider 120.

In order to effectively make use of such subscriptions, or for other reasons, content provider 120 may desire to have appropriate signals provided to them based on users' online activities. Specifically, content providers 120 may desire to have signals provided to them when users are online (e.g., are receptive to content), or when they take particular activity online. Even more particularly, content providers 120 may desire to have signals provided to them based on users online activities, even when those online activities occur with respect to other websites (e.g., domains) or communication channels that are not affiliated with that content provider 120 (e.g., when such online activities occur in association with a different web page 126 than those provided by the content provider 120, etc.). These signals may take multiple forms, including what are referred to as “third-party” signals where one content provider 120 (or other entity) is signaled based on a user being online (e.g., and exhibiting a particular interest) either on that content provider 120, website or domain or on another website or domain, or a “first-party” signal where a user at a user device 108 gets a signal (e.g., a push notification) from a website (e.g., a website for which the user did not register or provide permission to) through a website for which the user did register.

These signals may also be delivered through multiple channels including on these multiple channels substantially simultaneously. For example, while signals may be provided to a specified or provided interface, a signal may be provided in an email channel (e.g., to a specified or determined email address). In some cases signals may be particularly advantageous with email because signaling directly via email when a user is online (e.g., and interacting with the targeted interest) may lead to a higher rate of interaction. This is particularly valuable with email as the use of email may improve overall deliverability. Additionally, signals could be sent on multiple channels, for example a signal could be sent via an email while simultaneously sending a push notification to a signal recipient (e.g., referencing the email). By sending signals on multiple channels deliverability may also be improved.

Thus, signaling system 140 may store content provider identifiers 144 where each of those content provider identifiers 144 may be associated with, and identify, a content provider/signal recipient system 120 that desires to have signals provided to them. Signaling system 140 may also maintain a list of domains and associated domain labels 152 for content providers 120 (e.g., the domains or web pages provided by a content provider 120 may be associated with content provider identifier 144 for that particular content provider 120). These domain labels may specify attributes associated with domains or individual web pages 126 provided by the content providers such as interests, verticals, demographic information, etc. associated with these domains. Similarly, ad labels 154 for advertisements that may be provided by content providers 120 or other advertisement providers may also be maintained by signaling system 140 such that these labels may be determined in association with an advertisement provided to a user at a user device 108 (e.g., by a content provider 120 or other advertisement provider).

Each of the content providers/signaling recipients 120 may desire to have such signals provided to them based on one or more policies 146 (e.g., assigned a corresponding policy identifier 148 that may be associated with both the corresponding content provider identifier 144 which specified the policy 146 and the policy 146 itself). These policies 146 (also referred to as signal policies) may be specified by a content provider 120 (e.g., a user associated with content provider 120 through an interface or through some other channel).

Each of these policies 146 may thus be a “document” (e.g., data structure, key value pair, file, object, etc.) which specifies rules 158 (e.g., attributes or delivery rules) defining that policy 146. These rules 158 may include targeting rules defining an interest or other (targeting) criteria associated with the policy 146 such as a vertical or interest attribute (e.g., vehicles, technology, senior citizens, politics, etc.) for the policy 146. These targeting rules may also specify time frames associated with the targeting criteria, such as a past time period during which a particular targeting criteria may have occurred (e.g., a user has visited a web page associated with an “automotive” vertical in the last five days). It will be noted that the targeting criteria may include multiple criteria and may include an expression for combining or evaluating such criteria to determine if such targeting rules have been met.

Restriction or timing rules 158 on the policy 146 may also be specified for a policy 146, such as a (e.g., maximum) number of signals that may be sent for the policy 146 in a time period (or maximum number of signals per user in a time period) that the content provider 120 desires for that policy 146, or any information the content provider 120 desires to be provided with a signal based on the policy 146, etc. The rules 158 of policy 146 may also include signal delivery rules comprising a specification of a signal delivery (or transport) channel 182 through which they would like any signal associated with that policy 146 to be provided, along with what data regarding the user or events should be included in the signal (e.g., user ids 132, event data, etc.). These signal delivery channels 182 may, for example, be APIs, RESTful interfaces or some other interface such as an interface associated with the provisioning of the web pages 126 (websites) of the content provider 120 or a call center 125 affiliated with content provider 120. An example of a policy 146 is included in the Appendix.

Moreover, for each of the content providers 120, the signaling system 140 may maintain content provider user ids 132 for users associated with that content provider 120 (e.g., users who access the web sites or domains of that content provider 120 through web pages 126 or who have subscribed to notifications from that content provider 120). As discussed, the content provider user id 132 may be a hash of a user's email (e.g., for security purposes) or other substantially unique identifier for a user. Accordingly, these content provider user ids 132 may be associated with the content provider id 144 for that content provider 120 or may be associated with a signaling system unique user device identifier 142.

One or more web pages 126 provided by the content provider 120 may include an embed code 128. This embed code 128 can cause the web browser 110 rendering the web page 126 to request a signaling system agent 112 from signaling system 140 or another location (e.g., if the agent 112 is not already present or executing on the user device 108). The embed code 128 may comprise a script tag, an include tag or the like. The agent 112 may include code such as JavaScript or the like, which may be executed by the browser 110 at the user's device 108. A signaling system agent 112 may also be included in (e.g., embedded in) other applications 114 (e.g., “apps”) that are executed or installed on a user device 108 (e.g., native application or the like).

In an embodiment, the agent 112 is a program or script which executes on a website (e.g., web page 126 of a website) and is configured to generate and track a user device identifier that identifies one or more subscribers corresponding to a user device 108. The agent 112 may create a unique user identifier associated with user device 108 or a user on the user device 108 that may be passed to signaling system 140 and stored at signaling system 140. In an embodiment, the signaling system unique user device identifier 142 (SSUUID) (also referred to “signaling system user device identifier” or “signaling system user device identifier data”) may be stored in association with an identifier 144 of a content provider system 120. Advantageously, following the generation of the SSUUID, online events by a user or user device 108 may be identified and tracked.

In one embodiment, the SSUUID 142 may be associated with a user who has opted into or otherwise provided permission to “subscribe” to receive notifications or other data from a content provider 120 (e.g., through the content provider 120 web page 126 that they are accessing or through another channel). For example, a subscription can include a single messaging subscription which is generated when a user enables or allows notification permissions on a website. In an embodiment, the SSUUID 142 that is generated can be coupled with subscriber registration details to enable registration of the subscription such as a subscription endpoint, one or more encryption keys required for notification delivery, a subscription expiration time, etc. Thus, for example, a subscription may allow a push messaging system (e.g., associated with content provider 120) to send and deliver notifications to a user with such a subscription. Thus, this SSUUID 142 for a user may be stored at the signaling system 140. Specifically, each of the SSUUIDs 142 for a user may be associated with a corresponding content provider user id 132 for each of the content providers 120 for which that user has subscribed to received notifications.

To generate such a SSUUID 142 for example, agent 112 may detect a set of idempotent functions invoked by a web browser 110 of a user device. The set of functions is used to generate an output or identifier specific to the user device's web browser state or configuration. Example functions include, but are not limited to, static details provided by the browser such as the user agent information, whether localStorage is enabled, rendering images using Canvas and WebGL which add more variation between devices depending on browser capabilities (e.g., available fonts), etc. In an embodiment, the agent 112 or signaling system 140 generates a final unique value based on the combination of the output of the functions identified in the collection phase. For example, the unique identifier may be generated by concatenating the output of these functions and providing the concatenated outputs as an input to a one-way hashing function. Advantageously, the functions executed on the user device are idempotent, such that the same results are produced by the web browser 110 throughout the session as well as across multiple sessions on different websites. Examples of how such an identifier may be generated are described in U.S. Pat. No. 11,677,848 entitled “Subscription Management And Web-Based Activity Tracking In A Computing Environment” by Smith and Taylor issued on Jun. 13, 2023, which is hereby incorporated by reference in its entirety for all purposes.

Accordingly, signaling system 140 may provide an event tracking engine 172 for tracking users' online activities at the user device 108. Event tracking engine 172 may provide an interface for agents 112 to report events 162 such that they may be stored at the signaling system 140. Specifically, event tracking engine 172 may be a software interface capable of receiving and processing tracking events related to user or agent activity such as an HTTP API which receives tracking calls via POST requests from agent 112.

Namely, as a user accesses web page 126 from content provider 120 (or takes other online actions), the signaling system agent 112 may send user events 162 and the context of those events (e.g., data associated with a user's online activities, such as address for, or data related to, domains or web pages 126 accessed or other tracking information) to event tracking engine 172 of signaling system 140 in association with the SSUUID 142 for the user. Specifically, agent 112 may send tracking requests to an interface provided by event tracking engine 172, where those tracking requests include events 162. These events may include event data such as an identifier for the event, the user, the user device 108 or other context data associated with the event such as data on the content being viewed or interacted with. Thus, the signaling system 140 may store this user data 164 (including these reported events 162) at the signaling system 140 in association with the SSUUID 142. An example of event data for an event 162 is included in the Appendix. In the example included, there is a capture date, an SSUUID (e.g., labeled a “pushprint”), an IP address (e.g., labeled an “ipa”), an identifier for a web site, an identifier for an interest associated with the event (e.g., labeled “vertical” and other associated data.

Signaling engine 174 may utilize the events 162 stored by event tracking engine 172 to determine signals 190 to send to content providers 120, and send signals 190 to an associated content provider 120. In particular, as events 162 are stored by the event tracking engine 172, signaling engine 174 may process these events to determine if a signal 190 should be sent to a content provider 120 (or another location). In one embodiment, as events 162 are stored in association with SSUUID 142 for a user, it can be determined if a signal 190 should be sent based on the event 162. Accordingly, the SSUUID 142 associated with the received event 162 can be used to determine all associated content provider user ids 132 corresponding to the SSUUID 142 associated with the event. From these content provider user ids 132 associated with the user for whom the event 162 was generated, the associated set of content provider (ids 144) can be determined. Using the set of content provider ids 144 determined then, the set of policies 146 associated with each of those content provider ids 144 can be determined to be applicable to the event 162 and the event 162 associated with that policy 146 (e.g., stored in association with that policy 146).

In another embodiment, each of the policies 146 associated with a received event 162 can be determined by evaluating the event data of the received event 162 against the rules 158 of that policy 146 (e.g., the targeting rule defining an interest or other criteria associated with the policy 146). If the event data of the received event 162 matches the rules 158 of the policy (e.g., the interest or other criteria specified for the event meets the targeting rules for the criteria) the policy 146 may be determined to be an applicable policy 146 and the event 162 associated with that policy 146 (e.g., stored in association with that policy 146).

Each of these determined (e.g., applicable) policies 146 can be evaluated against the (context of the) received event 162 to determine if a signal 190 should be generated based on the received event 162. To determine if a received event 162 meets policy 146, in one embodiment a domain label 152 or ad label 154 associated with the event 162 may be determined and compared to the attributes or interests specified in association with the policy 146 (e.g., in the rules 158 associated with the policy 146). In particular, event 162 may include an identifier (e.g., a domain, address, or the like) of a web page 126 accessed by the user. The identifier can be utilized to access a domain label 152 or ad label 154 associated with the identifier (e.g., for the web page accessed) can then be used to evaluate (e.g., rules 158 of) policies 146 against the event 162. It will be noted here that, in some embodiments, events 162 associated with policy 146 may be stored in association with policy 146, content provider user id 132 or SSUUID 142, any rules 158 (e.g., targeting rules) of policy 146. Thus, both a received event 162 and historical events 162 may be stored in association with a policy and a user. Accordingly, if rules 158 for a policy 146 specify a context related to multiple events 162 or historical events 162, those rules 158 for the policy 146 may be evaluated against events 162 associated both with the user that generated the currently received event 162 and the policy 146 to determine if signal 190 should be sent based on the rules 158 of that policy 146.

If received event 162 (or the set of events 162 associated with the policy 146 and the user) meets a policy 146 (e.g., based on the evaluation of the context of the event 162 against the rules 158 (targeting rules) of the policy 162), a signal 190 may be added to signal queue 170. This signal 190 may include the event 162 that generated that signal (e.g., the context or data associated with the event 162), the signal delivery channel 182 specified for that policy that was met and other data related to the signal, such as the content provider user identifier 132 for the user associated with the event (e.g., the email or phone number of the user or MD5 hash of the email or phone number) and the policy identifier 148 for the policy that was met.

It will also be noted that other data from almost any number of data sources can be included in signal 190 as desired. For example, these data sources (including for example, third party Internet based data sources or the like) may be accessed from signaling system 140 based on a content provider user id 132 (e.g., the email or MD5 hash, etc.) to obtain data associated with that content provider user id 132 from that data source. This data may be included in signal 190 provided from signaling system 140.

Signaling engine 174 can then send signals from signal queue 170 to the respective content provider 120 associated with the signal 190. Specifically, the signaling engine 174 can obtain a signal 190 from the signal queue 170 and determine the delivery channel 182 associated with that signal 190. The signal 190 can then be sent to the content provider 120 identified by the content provider user id 144 through the delivery channel 182 specified for the met policy 146. In this manner, one event 162 (or set of events 162) associated with a user may trigger a signal 190 to one or more associated content provider 120 in a dynamic manner as that user is online or at the time a user is expressing a particular interest or taking another online activity.

In one embodiment, if the targeting rules 158 associated with a policy 146 (e.g., defining an interest or other attributes of an event) have been met but a restriction rule 158 associated with that policy 146 indicates a signal 190 should not be sent at that time (e.g., it is outside of a time period in which signals should be sent, such as business hours or too many signals 190 have been sent to a content provider 120 in a time period, etc.) a sticky signal 192 may be created. Such a sticky signal 192 may not be sent until such a time as the user associated with content provider user id 132 creates another event that meets such a restriction rules 158 (e.g., the number of signals is below a threshold, it is the proper time of day, etc.).

For example, a process for setting a sticky signal would create a session that may be time bound (e.g. a time bound session of 7 days) in the event tracking engine 172. Signaling engine 174 may then check whether this session is active during processing (e.g., at a time interval, based on an event or criteria, etc.) and if so may ignore certain unmet criteria.

It will be noted here that while embodiments as described have been described with respect to providing signals to content providers 120 associated with subscribed users generating those events, other embodiments may be equally effectively utilized to provide signals to content providers 120 (or other entities) to which a user has not subscribed or almost any entity desired. In particular, it will be noted here that content providers may be only content providers or content providers may also be signal recipients as well. Similarly, signal recipients may be only signal recipients, but signal recipients may also be content providers as well. Moreover, entities may be content providers in one context and signal recipients in another context. Thus, for example, content provider/signal recipient 120a may provide content such as web page 126 in one context and may also receive signals 190 in another context, including signals 190 related to a user's activity in association with content provided by another content provider/signal recipient 120b.

As discussed above, in certain instances it may be desired to send a signal from the user device itself as opposed to from the signaling system. By sending signals from the user device, data that is only available on the user device may be included in such signals. Additionally, data that may be objectionable or otherwise undesirable to send from the user device to the signaling system (e.g., because of size, storage constraints, security or data privacy reasons, etc.) may be provided from the user device in a signal sent from that user device. For example, in some instances, a signal may be provided to a signal recipient, where that signal recipient may have previously stored data associated with that signal recipient on the user device. The signal recipient may wish to be provided such data in a signal to be sent to that signal recipient. (e.g., cookie or other data previously placed on the user's device by an application or web page associated with the signal recipient, a user identifier specific to the signal recipient). Accordingly, in certain embodiments, when a signaling system determines a signal is to be sent to a signal recipient, the signaling system may send a signaling instruction to the user device that causes the signal to be sent from the user device to the signaling recipient.

FIGS. 2B-1 and 2B-2 (2A-2 (referred to collectively as FIG. 2B), depicts a block diagram of an architecture of a distributed network computer system for dynamic signaling including an embodiment of a signaling system adapted to cause a signal to be sent from the user device. In this FIGURE similar reference numerals are used to refer to like items as described with respect to FIG. 2A and will not be elaborated on further with respect to FIG. 2B. As discussed above, signaling system 140 can receive events 162 from the user device 108 and associate these events 162 with user id 132 or SSUUID 142 of the user interacting with the content at user device 108, or policy 146 met by event 162. Signaling system 140 can analyze events 162 associated with policies 146 according to the rules 158 defined by signal recipient 120 and determine that signal 190 is to be sent to signal recipient 120.

In this embodiment, signaling system 140 may send signaling instruction 178 to user device 108. This signaling instruction 178 may include, for example, an instruction to agent 112 on the user device 108 to send signal 190, data to be sent in signal 190, data to be obtained from user device 108 and include in signal 190, a mechanism (e.g., interface, destination, location, etc.) for providing signal 190 (e.g., as specified by signaling recipient 120), or other signaling data. For example, the signaling instruction 178 may include a URL or other location which may be accessed by agent 112 on the user device 108 to load signaling code 202 (e.g., a script available at the URL at signaling system 140, a pixel associated with signaling code 202 that may be inserted into the DOM of browser 110 at the user device 18, etc.). The signaling code 202 can be loaded (or otherwise accessed or instructed) on the user device 108. This signaling code 202 then sends the signal 190 based on the signaling instruction. Thus, in response to receiving signaling instruction 178, signal 190 may be sent from user device 108 to signal recipient 120 where signal 190 includes any data specified in rules 158 defined by signal recipient 120 and is sent or otherwise provided to signaling recipient 120 according to the mechanism specified by signal recipient 120.

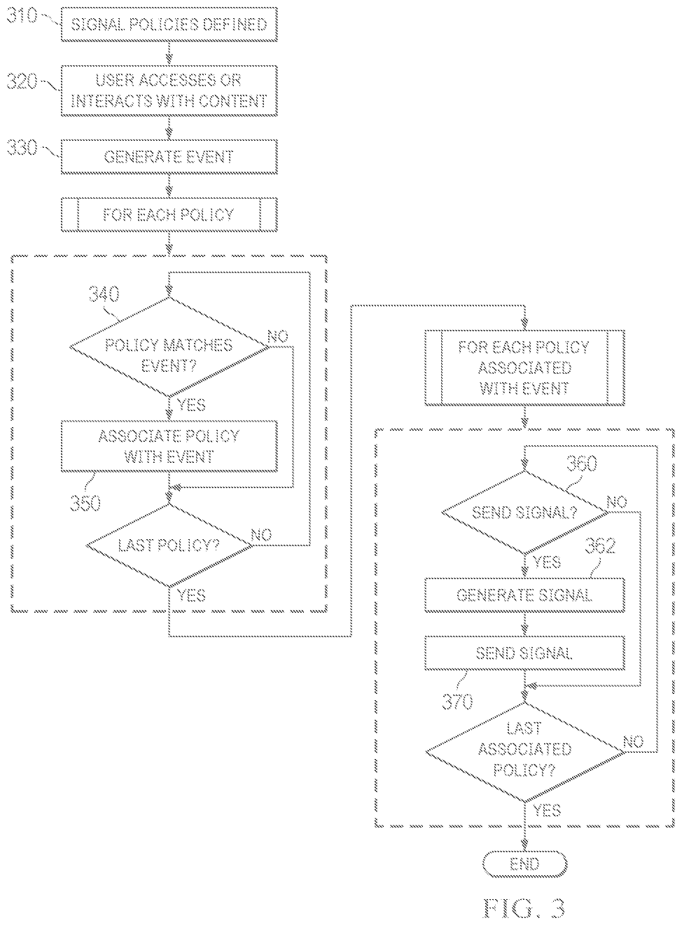

Referring now to FIG. 3, one embodiment of a method for sending a signal to a signal recipient based on a user's online activity is depicted. Various (e.g., one or more) signal recipients (e.g., potential signal recipient) may define signal policies (STEP 310). These policies may define when the signal recipient wants to receive a signal, what (e.g., data) the signals should include, how the signals should be provided to the signal recipient, or other definitional data for a potential signal.

Specifically, in some embodiments each of these policies specifies rules defining that policy. These rules may include targeting rules defining an interest or other criteria associated with the policy such as a vertical or interest attribute for the policy. These targeting rules may also specify time frames associated with the targeting criteria, such as a past time period during which a particular targeting criteria may have occurred. Restriction or timing rules may also be specified for a policy such as a (e.g., maximum) number of signals that may be sent to the signal recipient in association with the policy in a time period (or maximum number of signals per user in a time period). The rules may also specify the data the signal recipient desires to be provided in a signal generated based on that policy along with what data regarding the user or events should be included in the signal (e.g., user ids, event data, data related to content being viewed, etc.). The rules may also include signal delivery rules comprising a specification of a signal delivery (or transport) channel through which the signal recipient would like any signal associated with that policy to be provided,

As each user interacts with content (e.g., a web page or the like) (STEP 320), events related to that user's viewing or interaction with the accessed content may be generated (STEP 330). Specifically, as a user accesses web pages or other content an agent on the user's device may generate tracking events for user viewing or interaction with that content, wherein the events include context for those events. These events may be stored in association with that user.

The stored events may be used to determine signals to send to signal recipients. In particular, as events are received and stored they are used to determine if a signal should be sent to a signal recipient based on a signaling policy associated with that signaling recipient. In one embodiment, when an event is received each policy (e.g., from the various potential signal recipients) may be evaluated in association with that received event to determine if the event should be associated with that policy. The evaluation can be by evaluating the event data of the received event against the rules of that policy (e.g., to determine if the event data comprising an interest, criteria or other data associated with the event corresponds to the targeting rule defining an interest or other criteria associated with the policy) (STEP 340). If the event data of the received event matches the rules of the policy the policy may be determined to be an applicable policy and the received event associated with that policy. (Y Branch of STEP 340, STEP 350).

For each of the policies that the event is associated with, a determination can then be made if a signal should be sent to the signal recipient associated with that policy (STEP 360) based on the rules associated with that policy. Again, these rules may involve targeting rules defining an interest or other criteria associated with the policy such as a vertical or interest attribute or time frames associated with the targeting criteria, such as a past time period during which a particular targeting criteria may have occurred. The rules may also include restriction or timing rules for the policy, such as a (e.g., maximum) number of signals that may be sent for the policy in a time period (or maximum number of signals per user in a time period). Thus, to determine if a signal should be sent to the signal recipient based on the policy it can be determined if the most recent event associated with the user or the set of historical events stored in association with that policy and user meet both the targeting criteria and any timing rules specified for that policy.

When it is determined that a signal should be sent to the signal recipient based on the policy a signal can be generated to include the signal data specified by that policy (STEP 362). This signal data may include an identifier for the user (e.g., that generated the received event or events that caused the policy to be met), an identifier for the met policy, event data included in the event or set of events that caused the policy to be met, third party data or any other data specified by the rules of the policy.

The signal can then be delivered to the signal recipient according to the rules (e.g., the signal delivery rules) of the met policy (STEP 370). In one embodiment, the policy may specify a signal delivery (or transport) channel for delivery of the signal. These signal delivery channels may, for example, be APIs, RESTful interfaces or some other interface. For example, the signal may be sent from a signaling system directly to the signal recipient or a single instruction may be sent to the user device from which the event that caused the policy to be met was received, where the signaling instruction comprises the data for the signal. This signaling instruction may cause the signal to be sent from that user device to the specified signal delivery channel specified by the met policy. Accordingly, by sending such a signal to a signal recipient one event (or set of events) associated with a user may trigger a signal to one or more associated signal recipients in a dynamic manner as that user is online or at the time a user is expressing a particular interest or taking another online activity. Moreover, in certain embodiments that signal may be sent from the very user device which generated the event that resulted in such a signal being sent, allowing proprietary or other data stored on the user device to be sent in the signal. Additionally, such a signal may be sent from that user device to a signal recipient that is not associated with the content being viewed or interacted with at the device by the user that triggered that event, and where the signal recipient may be different than the content provider that provided such content.

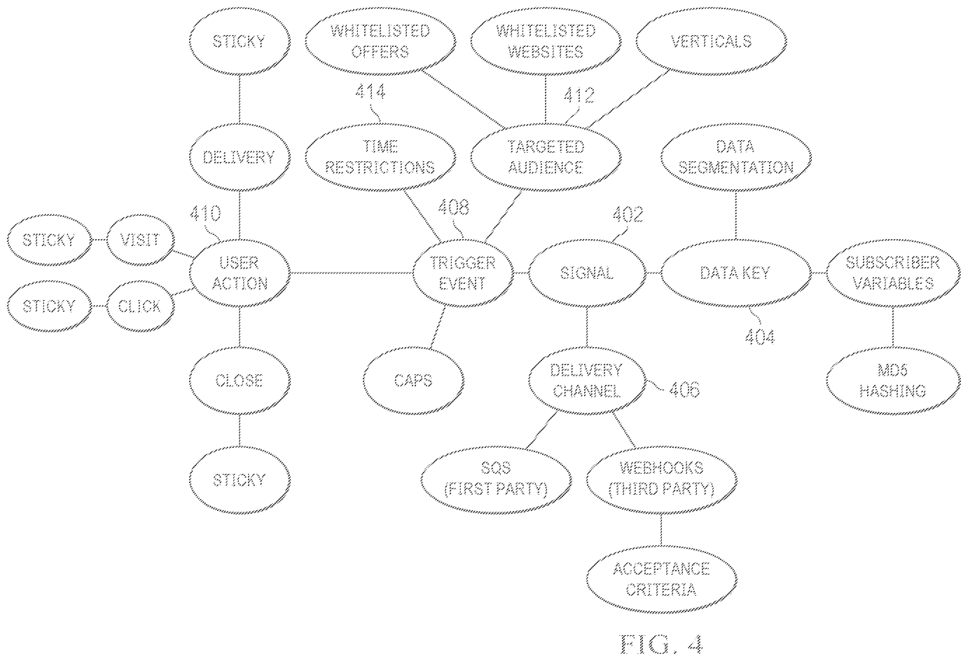

To aid in understanding certain embodiments, an example concept map for certain embodiments as described herein is depicted in FIG. 4. As can be seen from this depiction signal policy 402 includes a data key 404 which can be templated into a webhook URL. The collection phase for the data key 404 may be subject to segmentation, for example targeting a specific state or interest vertical. The data key 404 may include multiple data elements, and further it may be hashed upon collection. Signals from signal policy 402 are sent according to delivery channel 406 which may be, for example, an internal queue (or other type of storage) for processing in a signaling system, or a webhook to a third party domain. When used with a third party domain the webhook may be, for example, subject to acceptance criteria.

Signals are thus triggered by a trigger event 408 such as a user action event 410. That trigger event 408 may be restricted to a target audience 412 (e.g., whitelisted content or content in specific verticals). The trigger event 408 may also be subject to time restrictions 414 or event limits. The trigger event 408 may be associated with a user action event 410 such as a delivery, visit, or click. The trigger event 408 may also include a “sticky” context based on previous targeting for the user.

The invention and the various features and advantageous details thereof are explained more fully with reference to the nonlimiting embodiments that are illustrated in the accompanying drawings and detailed in the following description as included. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Generally then, the invention has been described with reference to specific embodiments. However, one of ordinary skill in the art appreciates that various modifications and changes can be made without departing from the scope of the invention. Accordingly, the Appendix is to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such an embodiment, feature, or function). Rather, the description is intended to describe illustrative embodiments, features, and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Reference throughout this specification to “one embodiment,” “an embodiment,” or “a specific embodiment,” “a specific implementation,” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Any suitable programming language can be used to implement the routines, methods or programs of embodiments of the invention described herein, including C, C++, Java, assembly language, etc. Different programming techniques can be employed such as procedural or object oriented. Data may be stored in a single storage medium or distributed through multiple storage mediums, and may reside in a single database or multiple databases (or other data storage techniques.

A “computer-readable medium” may be any medium that can contain, store, communicate, propagate, or transport the program for use by or in connection with the instruction execution system, apparatus, system or device. The computer readable medium can be, by way of example, only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code).

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

```
APPENDIX
Policy
{
  // An internal identifier for the policy
  “_id” : “62f098500000000000000000”,
  “name” : “Signals Policy Name”,
  // A policy “owner” identifier in the Pushnami system
  “accountId” : “62f098500000000000000000”,
  // The key to be absorbed in form data
  “keyIdentifier” : “custom_md5_variable_name”,
  // Defines a rest api as the delivery channel using HTTP GET requests
  “webhook” : {
    “url” : “https://some-rest-
api.com/signals?md5_email=signalId&api_key=62f098500000000000000000”,
    “method” : “GET”
  },
  // Versioning for backend processing behaviors
  “version” : 1,
  “enabled” : true,
  “extras” : {
    // This policy only collects data on publishers of one account id
    “collectionAccounts” : {
      “62f098500000000000000000” : true
    },
    // This policy runs from 9-5 EST
    “evaluationTimeRestrictions” : [
      {
        “start” : “0 9 * * 1-5”,
        “stop” : “0 17 * * 1-5”,
        “timezone” : “America/New_York”
      }
    ],
    // This policy does not collect data from a particular state
    “rules”: [
      [
        “state”,
        “NOTIN”,
        [
          “WY”
        ]
      ]
    ],
    // This policy considers the signal accepted by the client if the response includes
the word “success”
    “successCondition”: /success/,
    // This policy will pause daily after 1000 signals are accepted
    “acceptedCap”: {
      “enabled”: true,
      “limit”: 1000
    }
  }
}
Event Data
```

| capturedat | pushprint | ipa | website | vertical | tags | day |
|---|---|---|---|---|---|---|
| Aug. 8, | e07189db-a8e4-4f50- | 38.233.99. [symbol] | 62f143fef92dc36f1c6716a4 | news | {md5 = | Aug. 8, |
| 2022 8:50 | b1eb-6bd6ac1b733a | | | | 034f [symbol] | 2022 |
| Aug. 8, | 56e8bb1b-7fa0-435c- | 237.106.1 [symbol] | 62f14403a063e5603c999f80 | sweepstak [symbol] | {} | Aug. 8, |
| 2022 8:50 | a8ae-cdf06162b2d9 | | | | | 2022 |
| Aug. 8, | 406451bd-8262-4b90- | 9.72.158.1 | 62f14409fbb9784211e5dbdc | other | {} | Aug. 8, |
| 2022 8:50 | bfb1-efc6ceb6abde | | | | | 2022 |

[symbol]

indicates data missing or illegible when filed

What is claimed is:

1. A system for dynamic signaling based on user activity, comprising:
a processor; and
a non-transitory computer readable medium comprising instructions for:
storing a policy comprising a targeting rule and a signal delivery rule specifying a signal delivery channel and signal data;
receiving an event based on a user interaction with content at a user device of a user, wherein the content was provided from a content provider;
associating the event with the policy based on an evaluation of the event and the targeting rule of the policy;
generating a signal based on the association of the event with the policy, wherein the signal comprises the signal data specified in the signal delivery rule including an identifier for the policy and an identifier for the user; and
sending the generated signal to a signal recipient using the signal delivery channel specified in the signal delivery rule.

2. The system of claim 1, wherein generating the signal and sending the generated signal comprise:
sending a signal delivery instruction to the user device, the signal delivery instruction adapted to cause the signal to be generated at the user device and sent from the user device to the signal recipient using the signal delivery channel.

3. The system of claim 2, wherein the signal data of the signal includes data stored at the user device.

4. The system of claim 1, wherein the content provider and the signal recipient are different.

5. The system of claim 4, wherein the event is sent from an agent on the user device.

6. The system of claim 5, wherein the signaling instruction is sent to the agent, and the signal is sent from the agent.

7. The system of claim 5, wherein the signal is sent dynamically as the user is interacting with the content.

8. A method for dynamic signaling based on user activity, comprising:
storing a policy comprising a targeting rule and a signal delivery rule specifying a signal delivery channel and signal data;
receiving an event based on a user interaction with content at a user device of a user, wherein the content was provided from a content provider associating the event with the policy based on an evaluation of the event and the targeting rule of the policy;
generating a signal based on the association of the event with the policy, wherein the signal comprises the signal data specified in the signal delivery rule including an identifier for the policy and an identifier for the user; and
sending the generated signal to a signal recipient using the signal delivery channel specified in the signal delivery rule.

9. The method of claim 8, wherein generating the signal and sending the generated signal comprise:
sending a signal delivery instruction to the user device, the signal delivery instruction adapted to cause the signal to be generated at the user device and sent from the user device to the signal recipient using the signal delivery channel.

10. The method of claim 9, wherein the signal data of the signal includes data stored at the user device.

11. The method of claim 8, wherein the content provider and the signal recipient are different.

12. The method of claim 11, wherein the event is sent from an agent on the user device.

13. The method of claim 12, wherein the signaling instruction is sent to the agent, and the signal is sent from the agent.

14. The method of claim 12, wherein the signal is sent dynamically as the user is interacting with the content.

15. A non-transitory computer readable medium, comprising instructions for:
storing a policy comprising a targeting rule and a signal delivery rule specifying a signal delivery channel and signal data;
receiving an event based on a user interaction with content at a user device of a user, wherein the content was provided from a content provider;
associating the event with the policy based on an evaluation of the event and the targeting rule of the policy;
generating a signal based on the association of the event with the policy, wherein the signal comprises the signal data specified in the signal delivery rule including an identifier for the policy and an identifier for the user; and
sending the generated signal to a signal recipient using the signal delivery channel specified in the signal delivery rule.

16. The non-transitory computer readable medium of claim 15, wherein generating the signal and sending the generated signal comprise:
sending a signal delivery instruction to the user device, the signal delivery instruction adapted to cause the signal to be generated at the user device and sent from the user device to the signal recipient using the signal delivery channel.

17. The non-transitory computer readable medium of claim 16, wherein the signal data of the signal includes data stored at the user device.

18. The non-transitory computer readable medium of claim 15, wherein the content provider and the signal recipient are different.

19. The non-transitory computer readable medium of claim 18, wherein the event is sent from an agent on the user device.

20. The non-transitory computer readable medium of claim 19, wherein the signaling instruction is sent to the agent, and the signal is sent from the agent.

21. The non-transitory computer readable medium of claim 19, wherein the signal is sent dynamically as the user is interacting with the content.
